(19) United States
(12) Patent Application Publication
(10) Pub. No.: US 2022/0036237 A1
(43) Pub. Date: Feb. 3, 2022

(54) INFORMATION PROCESSING APPARATUS, INFORMATION PROCESSING METHOD, AND PROGRAM

(71) Applicant: NEC Corporation, Minato-ku, Tokyo (JP)

(72) Inventor: Natsuko YOSHIDA, Tokyo (JP)

(73) Assignee: NEC Corporation, Minato-ku, Tokyo (JP)

(21) Appl. No.: 17/277,198

(22) PCT Filed: Sep. 4, 2019
(86) PCT No.: PCT/JP2019/034820

§ 371 Date: Mar. 17, 2021

(30) Foreign Application Priority Data
Sep. 21, 2018 (JP) 2018-177631

(51) Int. Cl. G06N 20/00

(52) U.S. Cl. CPC G06N 20/00

(57) ABSTRACT

An information processing apparatus according to the present invention includes: a transforming unit configured to transform time-series data that is learning data into frequency domain data; a comparing unit configured to perform comparison between the frequency domain data corresponding to the learning data belonging to different classes, respectively; and a determining unit configured to determine a time width of the time-series data that is the learning data based on a result of the comparison between the frequency domain data. The time width is set at a time of performing machine learning of the time-series data.

### TECHNICAL FIELD

The present invention relates to an information processing apparatus that adjusts a parameter in time-series data analysis, an information processing method, and a program.

### BACKGROUND ART

Machine learning is a kind of artificial intelligence and is an algorithm that enables computers to “learn”. In machine learning, a prediction model is created by analyzing human-created model data. Use of a prediction model enables prediction of a future value (including a regression problem and a class identification problem).

A prediction problem in a multidimensional time series is a problem of predicting the value or class of an objective variable time series from a plurality of types of explanatory variable time series. Examples are prediction of a stock price from economic indicators, prediction of the weather from meteorological data, prediction of a failure of a mechanical system from sensor data, and so on. In solving such a prediction problem in a multidimensional time series, analysis using machine learning, especially, deep learning is often used.

At this time, a time-series length (hereinafter referred to as a “window width”) inputted into a prediction model has a great influence on the speed and accuracy of prediction. However, regarding a window width, there is a trade-off relationship in terms of accuracy and speed. In terms of speed, when it is desired to make real-time prediction such as inspection in a factory and failure prediction, it is required to make inferences at high speeds by making an input length (window width) as small as possible. On the other hand, in terms of accuracy, it is required to increase the amount of information as much as possible and perform inference with high accuracy by making the input length (window width) larger. Therefore, it is important to adjust a parameter relating to a window width in prediction of time series.

Patent Document 1: Japanese Patent Publication No. 5998811

As a parameter adjustment method relating to the window width of time-series data described above, a method as described in Patent Document 1 is disclosed. In this method, based on a frequency peak assumed in advance, a window width at which the peak can be detected is set.

However, such a method requires prior knowledge of data and domain knowledge. Then, in a case where such prior knowledge cannot be obtained, it is required to compare the results by brute force from a huge number of window width candidates, which causes a problem that a large number of man-hours for parameter adjustment are required.

### SUMMARY

Accordingly, an object of the present invention is to provide an information processing apparatus which can solve the problem that a large number of man-hours is required for setting of a window width in time-series data, an information processing method, and a program.

An information processing apparatus according to an aspect of the present invention includes: a transforming unit configured to transform time-series data that is learning data into frequency domain data; a comparing unit configured to perform comparison between the frequency domain data corresponding to the learning data belonging to different classes, respectively; and a determining unit configured to determine a time width of the time-series data that is the learning data based on a result of the comparison between the frequency domain data. The time width is set at a time of performing machine learning of the time-series data.

Further, a computer program according to another aspect of the present invention includes instructions for causing an information processing apparatus to realize: a transforming unit configured to transform time-series data that is learning data into frequency domain data; a comparing unit configured to perform comparison between the frequency domain data corresponding to the learning data belonging to different classes, respectively; and a determining unit configured to determine a time width of the time-series data that is the learning data based on a result of the comparison between the frequency domain data. The time width is set at a time of performing machine learning of the time-series data.

Further, an information processing method according to another aspect of the present invention includes: transforming time-series data that is learning data into frequency domain data; performing comparison between the frequency domain data corresponding to the learning data belonging to different classes, respectively; and determining a time width of the time-series data that is the learning data based on a result of the comparison between the frequency domain data, the time width being set at a time of performing machine learning of the time-series data.

With the configurations described above, the present invention enables decrease of man-hours required for setting of a window width in time-series data.

### BRIEF DESCRIPTION OF DRAWINGS

FIG. 1 is a block diagram showing a configuration of an information processing apparatus in a first example embodiment of the present invention;

FIG. 2 is a view showing an example of processing by the information processing apparatus disclosed in FIG. 1;

FIG. 3 is a view showing an example of processing by the information processing apparatus disclosed in FIG. 1;

FIG. 4 is a flowchart showing an operation of the information processing apparatus disclosed in FIG. 1;

FIG. 5 is a flowchart showing an operation of the information processing apparatus disclosed in FIG. 1;

FIG. 6 is a block diagram showing a configuration of an information processing apparatus in a second example embodiment of the present invention;

FIG. 7 is a view showing an example of processing by the information processing apparatus disclosed in FIG. 6;

FIG. 8 is a flowchart showing an operation of the information processing apparatus disclosed in FIG. 6; and

FIG. 9 is a block diagram showing a configuration of an information processing apparatus in a third example embodiment of the present invention.

### EXAMPLE EMBODIMENTS

### First Example Embodiment

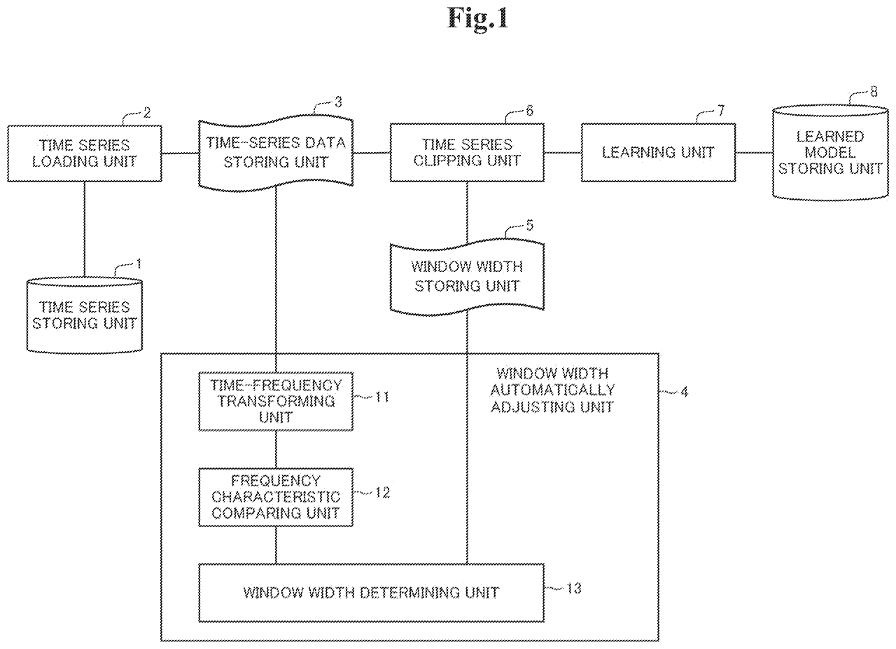

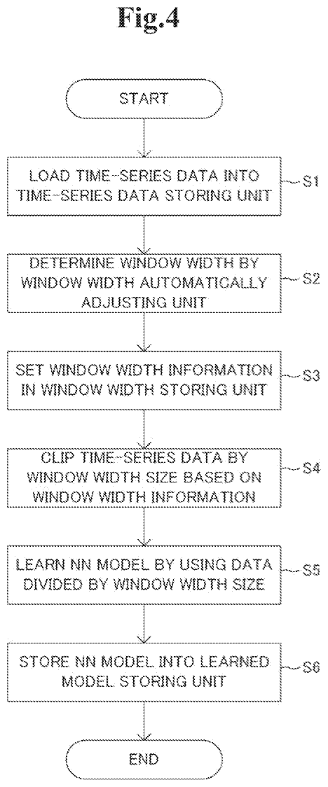

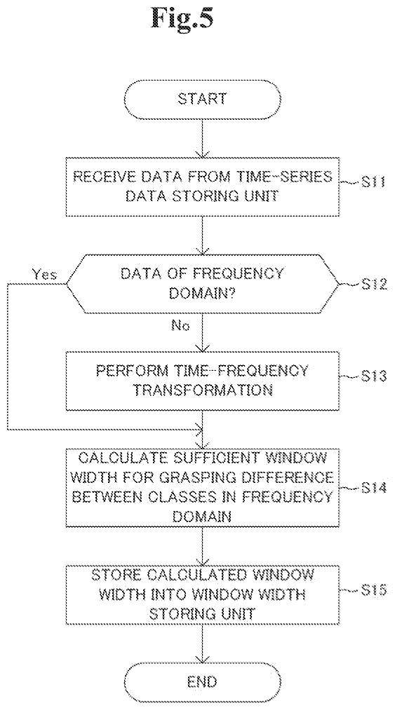

A first example embodiment of the present invention will be described with reference to FIGS. 1 to 5. FIGS. 1 to 3 are views for describing a configuration of an information processing apparatus. FIGS. 4 and 5 are views for describing an operation of the information processing apparatus.

### Configuration

The present invention is configured by one or a plurality of information processing apparatuses each including an arithmetic logic unit and a storage unit. The information processing apparatus according to the present invention has a function of performing machine learning by using time-series data. To be specific, as will be described below, the information processing apparatus has a function of calculating a frequency difference characteristic between time-series data and thereby automatically determining an optimal window length for prediction (including a regression problem and a class identification problem) from the characteristic of multidimensional time-series data. In this example embodiment, a case of solving a class identification problem by using deep learning will be described, but the information processing apparatus according to the present invention can be applied to solution of any problem.

To be specific, as shown in FIG. 1, the information processing apparatus in this example embodiment includes a time series loading unit 2, a window width automatically adjusting unit 4, a time series clipping unit 6, and a learning unit 7, which are structured by the arithmetic logic unit executing a program. The window width automatically adjusting unit 4 includes a time-frequency transforming unit 11, a frequency characteristic comparing unit 12, and a window width determining unit 13. Moreover, the information processing apparatus includes a time series storing unit 1 and a learned model storing unit 8 that are formed in a storage unit such as an auxiliary storage unit, and includes a time-series data storing unit 3 and a window width storing unit 5 that are formed in a storage unit such as a main storage unit. Below, the respective components will be described in detail.

In the time series storing unit 1, all time-series data used in learning (and corresponding ground truth labels) are stored. The time series loading unit 2 loads time-series data to be used for learning from the time series storing unit 1, and stores the loaded time-series data into the time-series data storing unit 3. In the time-series data storing unit 3, the time-series data passed from the time series loading unit 2 and a ground truth label corresponding thereto are stored. Thus, in the information processing apparatus, it is possible to designate an address and thereby access the time-series data stored in the time-series data storing unit 3. Then, by using such time-series data, a window width is determined by the respective units 11, 12 and 13 included by the window width automatically adjusting unit 4.

A Window Width Automatically Adjusting Unit

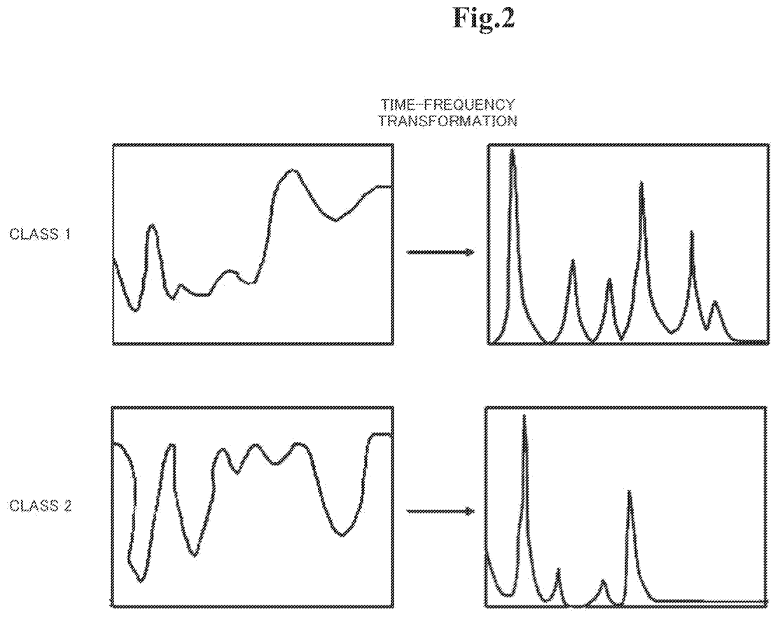

The time-frequency transforming unit 11 (a transforming unit) receives time-series data from the time-series data storing unit 3, and performs time-frequency transformation thereon. At this time, the time-frequency transforming unit 11 transforms the time-series data into frequency domain data for each explanatory variable of the time-series data and for each class associated with the ground truth label. An example of time-frequency transformation of learning data is shown in FIG. 2 In FIG. 2, the upper part shows how time-series data (left side) belonging to a class 1 of a predetermined explanatory variable is transformed into frequency domain data (right side), and the lower part shows how time-series data (left side) belonging to a class 2 of the same explanatory variable is transformed into frequency domain data (right side).

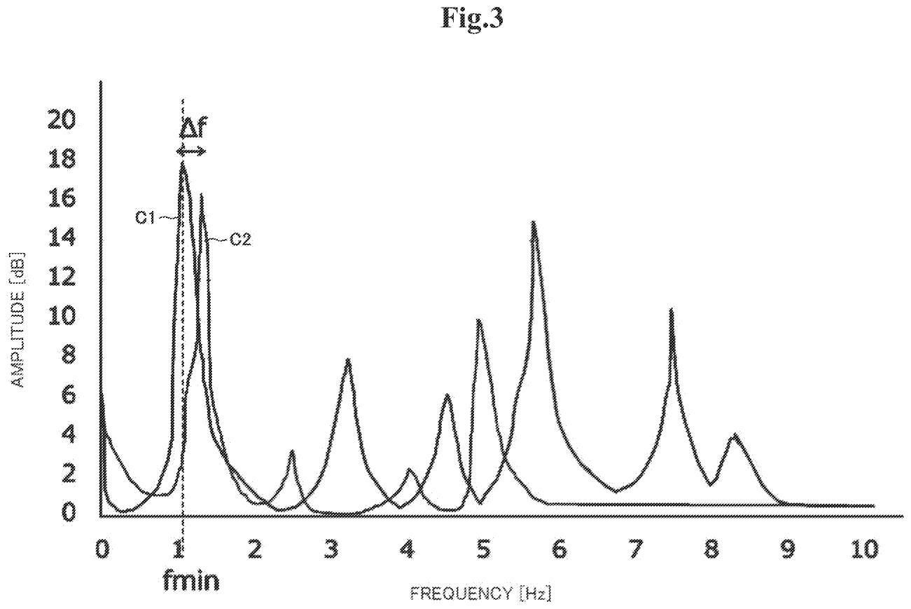

The frequency characteristic comparing unit 12 (a comparing unit, a determining unit) compares frequency domain data belonging to different classes, respectively, with each other for each explanatory variable. To be specific, the frequency characteristic comparing unit 12 calculates the difference between frequency domain data C1 and C2 belonging to different classes 1 and 2 of the same explanatory variable shown in FIG. 2 with each other. For example, as shown in FIG. 3, the frequency characteristic comparing unit 12 finds a frequency difference at frequency peak locations of the frequency domain data C1 and C2.

Then, the frequency characteristic comparing unit 12 calculates a sufficient window width for enabling detection of the difference between the different classes 1 and 2 for each explanatory variable based on the result of comparison between the frequency domain data belonging to the different classes of the explanatory variable, and stores the window width as a window width candidate into the window width storing unit 5. At this time, the frequency characteristic comparing unit 12 sets the window width to be larger as the difference in frequency domain data between classes is smaller in order to grasp the difference, and sets the window width to be smaller as the difference is larger.

A method by which the frequency characteristic comparing unit 12 calculates a window width from frequency domain data will be described using two examples.

### Example 1

First, as shown in FIG. 3, the frequency characteristic comparing unit 12 calculates, for each explanatory variable, the top N frequency peak locations of the frequency domain data C1 and C2 of the classes 1 and 2 and sorts them in order of frequency. For example, the frequency characteristic comparing unit 12 finds the frequency peaks of the class 1=(f1, f2, f3) and the frequency peaks of the class 2=(f1′, f2′, f3′), and calculates the frequency differences between the frequency peaks of the respective classes C1 and C2. Then, the frequency characteristic comparing unit 12 obtains a frequency resolution Δf required for prediction from the minimum value of the frequency differences at the frequency peak locations. After that, the frequency characteristic comparing unit 12 calculates a required window width T=1/Δf for each explanatory variable, and stores the window width candidate into the window width storing unit 5. In this example, the top three frequency peaks in each class are used, but a value at only the highest frequency peak locations may be used for each class, or a value at peak locations satisfying another condition may be used.

### Example 2

First, as shown in FIG. 3, the frequency characteristic comparing unit 12 calculates, for each explanatory variable, the top N frequency peak locations of the frequency domain data C1 and C2 of the classes 1 and 2 and sorts them in order of frequency. For example, the frequency characteristic comparing unit 12 finds the frequency peaks of the class 1=(f1, f2, f3) and the frequency peaks of the class 2=(f1′, f2′, f3′). Then, the frequency characteristic comparing unit 12 finds the minimum frequency fmin of the frequency peaks. After that, the frequency characteristic comparing unit 12 calculates a required window width T=1/fmin for each explanatory variable, and stores the window width candidate into the window width storing unit 5.

The window width determining unit 13 (determining unit) determines an appropriate window width based on the window width candidates calculated for the respective explanatory variables by the frequency characteristic comparing unit 12, and stores it into the window width storing unit 5. For example, the window width determining unit 13 determines a window width having the maximum length as a final window width from among the window width candidates calculated for the respective explanatory variables, or determines a window width having the minimum length as a final window width from among the window width candidates calculated for the respective explanatory variables.

In the window width storing unit 5, a certain value is initially stored as a window width initial value and, after the calculation by the window width automatically adjusting unit 4 described above, the calculated window width candidate is stored. Finally, a window width determined from among the window width candidates is stored, and the window width is outputted to the time series clipping unit 6.

The time series clipping unit 6 receives time-series data, which is learning data, from the time-series data storing unit 3, clips the time-series data by a window width, that is, a time width outputted by the window width storing unit 5, and passes the data to the learning unit 7.

The learning unit 7 receives time-series data clipped by the determined window width from the time series clipping unit 6, and performs learning by using the time-series data. Then, the learning unit 7 stores a learned model such as a neural network model generated by the learning into the learned model storing unit 8.

### Operation

Next, an operation of the information processing apparatus described above will be described with reference to the flowcharts of FIGS. 4 and 5. FIG. 4 shows an operation of the entire information processing apparatus shown in FIG. 1. FIG. 5 shows an operation of the window width automatically adjusting unit 4 shown in FIG. 2.

First, the time series loading unit 2 retrieves time-series data stored in the time series storing unit 1, and stores the time-series data into the time-series data storing unit 3 on a main storing unit (a memory) (step S1). Then, the window width automatically adjusting unit 4 determines a window width by using the time-series data stored in the time-series data storing unit 3 (step S2). Below, processing by the window width automatically adjusting unit 4 will be described with reference to FIG. 5.

First, the time-frequency transforming unit 11 receives time-series data from the time-series data storing unit 3 (step S11), and performs time-frequency transformation (NO at step S12, step S13). At this time, in a case where the received data is data of frequency domain from the beginning, the transformation process can be omitted (YES at step S12).

Subsequently, the frequency characteristic comparing unit 12 calculates a frequency difference between classes for each explanatory variable by using the frequency domain data, and calculates a sufficient window width for grasping the difference (step S14). At this time, the frequency characteristic comparing unit 12 sets the window width to be larger as the difference between classes is smaller in order to grasp the difference, and sets the window width to be smaller as the difference is larger. An example of a method for calculating the window width is, as described before, to find the frequency peak locations of the frequency domain data of the respective classes for each explanatory variable and calculate the window width based on the frequency difference between the frequency peak locations or the minimum frequency. Then, the frequency characteristic comparing unit 12 stores the window width calculated for each explanatory variable as a window width candidate into the window width storing unit 5 (step S15).

Subsequently, the window width determining unit 13 determines an appropriate window width based on the window width candidates calculated for the respective explanatory variables (step S2). For example, the window width determining unit 13 determines a window width having the maximum length or a window width having the minimum length as a final window width from among the window width candidates calculated for the respective explanatory variables. With this, the determined window width is stored and set in the window width storing unit 5 as window width information representing a window width used at the time of clipping time-series data (step S3).

After that, the time series clipping unit 6 receives time-series data, which is learning data, from the time-series data storing unit 3, clips the time-series data by the window width, that is, the time width outputted from the window width storing unit 5, and passes the data to the learning unit 7 (step S4). Then, the learning unit 7 receives the time-series data clipped by the determined window width from the time series clipping unit 6, and performs learning by using the time-series data (step S5). The learning unit 7 stores a learned model such as a neural network model generated by the learning into the learning model storing unit 8 (step S6).

As described above, according to the present invention, time-series data is transformed into frequency domain data, and a window width, which is a time width for clipping the time-series data, is automatically adjusted by using a frequency difference characteristic between the frequency domain data. With this, even when it is impossible to obtain prior knowledge about data and domain knowledge, it is possible to set a parameter, which is an appropriate window width, and it is possible to reduce man-hours for adjusting such a parameter.

### Second Example Embodiment

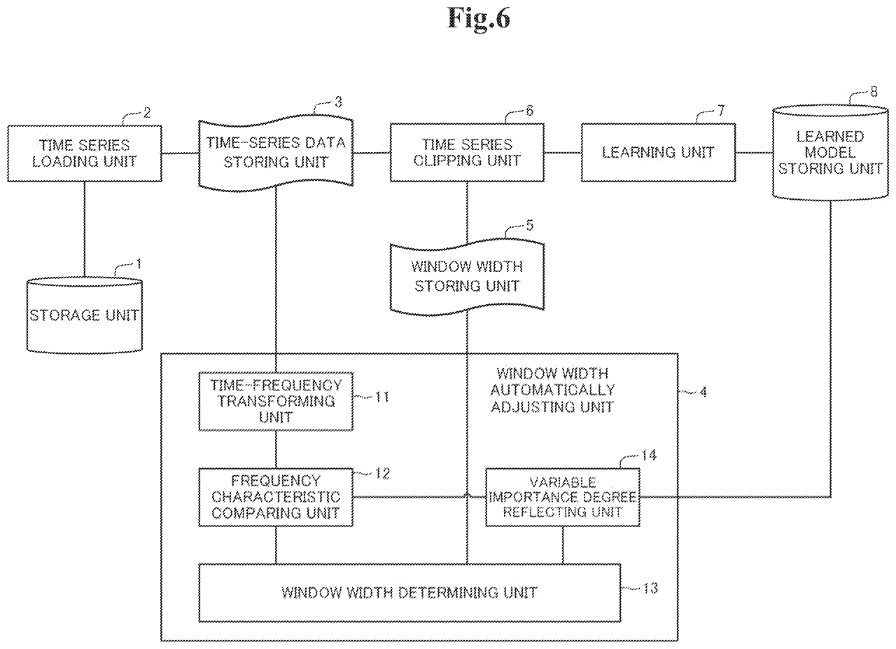

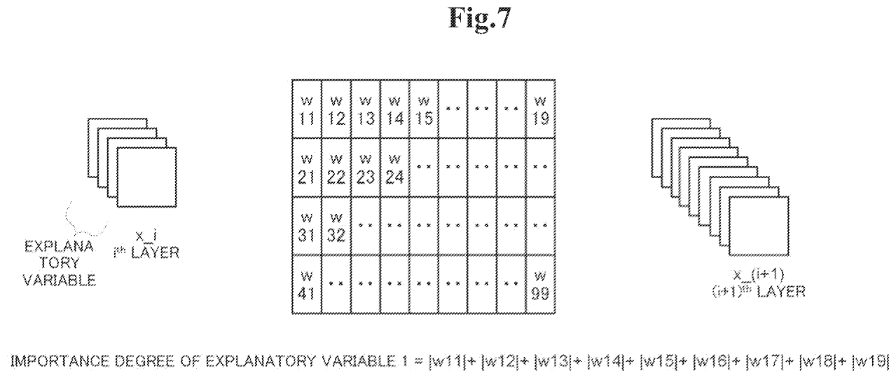

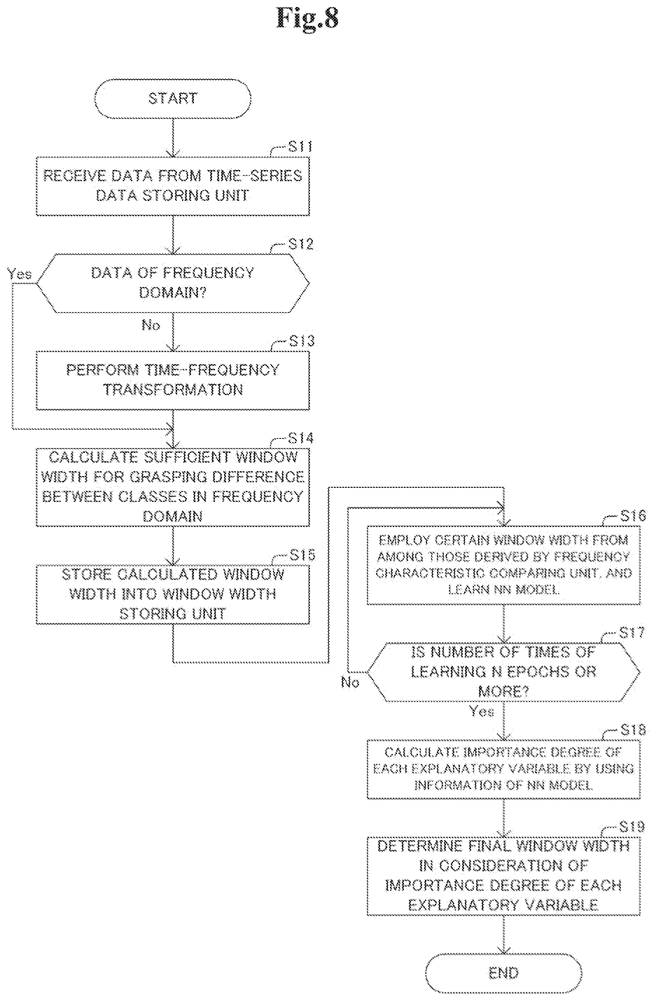

Next, a second example embodiment of the present invention will be described with reference to FIGS. 6 to 8. FIGS. 6 and 7 are views for describing a configuration of an information processing apparatus. FIG. 8 is a view for describing an operation of the information processing apparatus.

The first example embodiment described above is targeted at the class identification problem. This example embodiment can also be applied to the regression problem. For example, it is possible to, by performing clustering on a regression label and considering as a plurality of classes, apply the function of window width automatic adjustment.

### Configuration

The information processing apparatus in this example embodiment includes, in addition the same components as in the first example embodiment described above, a variable importance degree reflecting unit 14 structured by the arithmetic logic unit executing a program. Below, a configuration different from the first example embodiment will be mainly described.

First, as described above, the learning unit 7 selects an appropriate window width from among window width candidates found for the respective explanatory variables, and learns a learned model by using the window width as an initial window width. Then, after learning is performed k times, the variable importance degree reflecting unit 14 (an importance degree calculating unit) calculates an importance degree of each explanatory variable based on a ratio at which the explanatory variable contributes to the output of the learned model.

An example of calculation of the importance degree of an explanatory variable by the variable importance degree reflecting unit 14 will be described. Here, as an example, a case of using a CNN (Convolutional Neural Network) as the leaned model will be described with reference to FIG. 8. In the first convolution layer of CNN, the L1 norm of a weight for each explanatory variable input is the importance degree of the explanatory variable. When the number of output channels of the first convolution layer is nine, the importance degree of an explanatory variable k is calculated by the following equation.

Importance degree of explanatory variable k=|wk1|+|wk2|+|wk3|+|wk4|+|wk5|+|wk6|+|wk7|+|wk8|+|wk9|

Then, the window width determining unit 13 in this example embodiment calculates and determines a final window width based on window width candidates corresponding to the top M explanatory variables of high importance degrees. The symbols K and M are any integers. As an example, the window width determining unit 13 determines, as the window width, the longest window width that satisfies the system requirements from among the window width candidates for the top L variables whose variable importance degrees are higher than the other values (L is any integer). However, the window width determining unit 13 may determine the window width by any method.

### Operation

Next, an operation of the information processing apparatus in this example embodiment will be described with reference to the flowchart of FIG. 8. FIG. 8 mainly shows an operation of the window width automatically adjusting unit 4 and the learning unit 7 in this example embodiment, and shows a flow added to the flow from step S11 to step S15 described with reference to FIG. 5 in the first example embodiment.

First, as described above, when window width candidates are calculated by the frequency characteristic comparing unit 12 at step S15, a certain value is selected as a window width from among the window width candidates, and learning is repeatedly performed certain times by the learning unit 7 (step S16). After that, when learning is performed a plurality of times (YES at step S17), the variable importance degree reflecting unit 14 retrieves information relating to a created learned model from the learned model storing unit 8, and calculates the importance degree of each explanatory variable based on a ratio at which the explanatory variable contributes to the output of the model (step S18).

After the importance degrees of the explanatory variables are calculated, the window width determining unit 13 reflects the variable importance degrees and the system requirements to the window width candidates of the respective explanatory variables, and determines a window width (step S19). After that, the window width determining unit 13 stores the determined window width into the window width storing unit 5.

As described above, in this example embodiment, in a case where there are a plurality of explanatory variables, the importance degrees of the explanatory variables are calculated by using a learned model, and a window width is determined by using the importance degrees from among window width candidates found by the number of the explanatory variables.

### Third Exemplary Embodiment

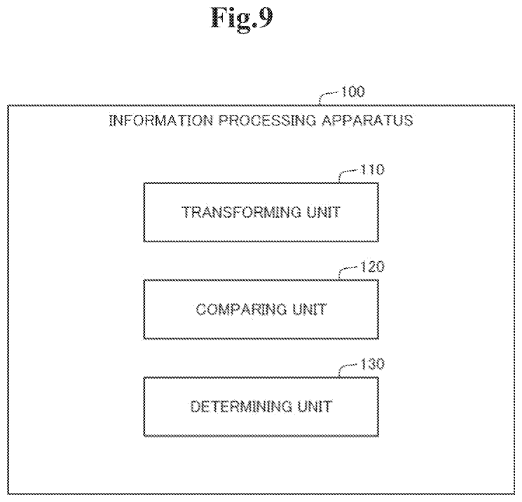

Next, a third example embodiment of the present invention will be described with reference to FIG. 9. FIG. 9 is a block diagram showing a configuration of an information processing apparatus in the third example embodiment. In this example embodiment, the overview of the configuration of the information processing apparatus described in the first example embodiment is shown.

As shown in FIG. 9, an information processing apparatus 100 in this example embodiment includes: a transforming unit 110 configured to transform time-series data, which is learning data, into frequency domain data; a comparing unit 120 configured to compare the frequency domain data that belong to different classes, respectively, and that correspond to the learning data; and a determining unit 130 configured to determine a time width of the time-series data that is set at the time of performing machine learning of the time-series data, which is the learning data, based on a result of the comparison of the frequency domain data.

The transforming unit 110, the comparing unit 120, and the determining unit 130 are realized by the information processing apparatus executing a program.

Then, the information processing apparatus 100 with the above configuration operates to execute processing of: transforming time-series data, which is learning data, into frequency domain data; comparing the frequency domain data that belong to different classes, respectively, and that correspond to the learning data; and determining a time width of the time-series data that is set at the time of performing machine learning of the time-series data, which is the learning data, based on a result of the comparison of the frequency domain data.

According to the invention described above, time-series data is transformed into frequency domain data, and a time width for clipping the time-series data is automatically adjusted in accordance with the result of comparison between the classes of the frequency domain data. With this, even when it is impossible to obtain prior knowledge about data and domain knowledge, it is possible to set an appropriate window width, that is a parameter, and it is possible to reduce man-hours for adjusting the parameter.

### Supplementary Notes

The whole or part of the example embodiments disclosed above can be described as the following supplementary notes. Below, the overview of the configurations of the information processing apparatus, the information processing method and the program according to the present invention will be described. However, the present invention is not limited to the following configurations.

### Supplementary Notes 1

An information processing apparatus comprising:

a transforming unit configured to transform time-series data that is learning data into frequency domain data;

a comparing unit configured to perform comparison between the frequency domain data corresponding to the learning data belonging to different classes, respectively; and

a determining unit configured to determine a time width of the time-series data that is the learning data based on a result of the comparison between the frequency domain data, the time width being set at a time of performing machine learning of the time-series data.

### Supplementary Notes 2

The information processing apparatus according to Supplementary Note 1, wherein:

the comparing unit is configured to calculate a frequency difference between the frequency domain data at frequency peak locations; and

the determining unit is configured to determine the time width based on the frequency difference between the frequency domain data at the frequency peak locations.

### Supplementary Notes 3

The information processing apparatus according to Supplementary Note 2, wherein the determining unit is configured to determine the time width so that the time width is larger as a value of the frequency difference is smaller.

### Supplementary Notes 4

The information processing apparatus according to Supplementary Note 2 or 3, wherein the determining unit is configured to determine the time width based on the frequency difference between the frequency domain data at locations where frequency peaks of the frequency domain data are determined to be high according to a preset standard.

### Supplementary Notes 5

The information processing apparatus according to any of Supplementary Notes 1 to 4, wherein the determining unit is configured to determine the time width based on a minimum value of frequencies at frequency peak locations of the frequency domain data.

### Supplementary Notes 6

The information processing apparatus according to any of Supplementary Notes 1 to 5, wherein:

the transforming unit is configured to transform the time-series data into the frequency domain data for each explanatory variable of the learning data;

the comparing unit is configured to perform comparison between the frequency domain data corresponding to the learning data belonging to different classes, respectively, for each explanatory variable of the learning data; and

the determining unit is configured to calculate the time width based on a difference between the frequency domain data for each explanatory variable of the learning data, and determine the time width based on the calculated time width of each explanatory variable.

### Supplementary Notes 7

The information processing apparatus according to Supplementary Note 6, comprising:

a learning unit configured to perform machine learning by a predetermined learned model by use of the time-series data that is the learning data set by the determined time width; and

an importance degree calculating unit configured to, based on a result of the machine learning, for each explanatory variable of the learning data, calculate an importance degree of the explanatory variable,

wherein the determining unit is configured to determine the time width based on the importance degree of each explanatory variable and the time width calculated for each explanatory variable.

### Supplementary Notes 8

The information processing apparatus according to Supplementary Note 7, wherein:

the importance degree calculating unit is configured to calculate the importance degree of the explanatory variable based on a ratio at which the explanatory variable contributes to output in the learned model; and

the determining unit is configured to determine the time width based on the time width of the explanatory variable whose importance degree of the explanatory variable is determined to be a high value according to a preset standard.

### Supplementary Notes 9

A computer program comprising instructions for causing an information processing apparatus to realize:

a transforming unit configured to transform time-series data that is learning data into frequency domain data;

a comparing unit configured to perform comparison between the frequency domain data corresponding to the learning data belonging to different classes, respectively; and

a determining unit configured to determine a time width of the time-series data that is the learning data based on a result of the comparison between the frequency domain data, the time width being set at a time of performing machine learning of the time-series data.

### Supplementary Notes 10

An information processing method comprising:

transforming time-series data that is learning data into frequency domain data;

performing comparison between the frequency domain data corresponding to the learning data belonging to different classes, respectively; and

determining a time width of the time-series data that is the learning data based on a result of the comparison between the frequency domain data, the time width being set at a time of performing machine learning of the time-series data.

### Supplementary Notes 11

The information processing method according to Supplementary Note 10, wherein:

at a time of performing the comparison between the frequency domain data, a frequency difference between the frequency domain data at frequency peak locations is calculated; and

the time width is determined based on the frequency difference between the frequency domain data at the frequency peak locations.

### Supplementary Notes 12

The information processing method according to Supplementary Note 11, wherein the time width is determined so that the time width is larger as a value of the frequency difference is smaller.

### Supplementary Notes 13

The information processing method according to Supplementary Note 11 or 12, wherein the time width is determined based on the frequency difference between the frequency domain data at locations where frequency peaks of the frequency domain data are determined to be high according to a preset standard.

### Supplementary Notes 14

The information processing method according to any of Supplementary Notes 10 to 13, wherein the time width is determined based on a minimum value of frequencies at frequency peak locations of the frequency domain data.

### Supplementary Notes 15

The information processing method according to any of Supplementary Notes 10 to 14, wherein:

the time-series data is transformed into the frequency domain data for each explanatory variable of the learning data;

comparison between the frequency domain data corresponding to the learning data belonging to different classes, respectively, is performed for each explanatory variable of the learning data; and

the time width is calculated based on a difference between the frequency domain data for each explanatory variable of the learning data, and the time width is determined based on the calculated time width of each explanatory variable.

### Supplementary Notes 16

The information processing method according to Supplementary Note 15, comprising:

after determining the time width, performing machine learning by a predetermined learned model by use of the time-series data that is the learning data set by the determined time width;

based on a result of the machine learning, for each explanatory variable of the learning data, calculating an importance degree of the explanatory variable; and further

determining the time width based on the importance degree of each explanatory variable and the calculated time width of each explanatory variable.

### Supplementary Notes 17

The information processing method according to Supplementary Note 16, comprising:

calculating the importance degree of the explanatory variable based on a ratio at which the explanatory variable contributes to output in the learned model; and

determining the time width based on the time width of the explanatory variable whose importance degree of the explanatory variable is determined to be a high value according to a preset standard.

The program can be stored by using various types of non-transitory computer-readable mediums and supplied to a computer. The non-transitory computer-readable mediums include various types of tangible storage mediums. The non-transitory computer-readable mediums include, for example, a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, a semiconductor memory (for example, a mask ROM, a PROM (Programmable ROM), an EPROM (Erasable PROM), a flash ROM, a RAM (Random Access Memory)). The program may be supplied to a computer by using various types of transitory computer-readable mediums. The transitory computer-readable mediums include, for example, an electric signal, an optical signal, and an electromagnetic wave. The transitory computer-readable medium can supply a program to a computer via a wired communication channel such as an electric wire and an optical fiber or via a wireless communication channel.

Thus, although the present invention has been described with reference to the example embodiments and so on, the present invention is not limited to the example embodiments described above. The configurations and details of the present invention can be changed in various manners that can be understood by one skilled in the art within the scope of the present invention.

The present invention is based upon and claims the benefit of priority from Japanese patent application No. 2018-177631, filed on Sep. 21, 2018, the disclosure of which is incorporated herein in its entirety by reference.

### DESCRIPTION OF NUMERALS

1 time series storing unit
2 time series loading unit
3 time-series data storing unit
4 window width automatically adjusting unit
5 window width storing unit
6 time series clipping unit
7 learning unit
8 learned model storing unit
11 time-frequency transforming unit
12 frequency characteristic comparing unit
13 window width determining unit
14 variable importance degree reflecting unit
100 information processing apparatus
110 transforming unit
120 comparing unit
130 determining unit

What is claimed is:

1. An information processing apparatus comprising:
a memory storing instructions; and
at least one processor configured to execute the instructions the instructions comprising:
transforming time-series training data into frequency domain data;
comparing the frequency domain data that belong to different classes, respectively, the frequency domain data corresponding to the time-series training data; and
determining a time width of the time-series training data based on a comparison result of the frequency domain data, the time width being set at a time of performing machine learning of the time-series training data.

2. The information processing apparatus according to claim 1, wherein the instructions comprise:
calculating a frequency difference between the frequency domain data at frequency peak locations; and
determining the time width based on the frequency difference between the frequency domain data at the frequency peak locations.

3. The information processing apparatus according to claim 2, wherein the instructions comprise determining the time width so that the time width is larger as a value of the frequency difference is smaller.

4. The information processing apparatus according to claim 2, wherein the instructions comprise determining the time width based on the frequency difference between the frequency domain data at locations where frequency peaks of the frequency domain data are determined to be high according to a preset standard.

5. The information processing apparatus according to claim 1, wherein the instructions comprise determining the time width based on a minimum value of frequencies at frequency peak locations of the frequency domain data.

6. The information processing apparatus according to claim 1, wherein the instructions comprise:
transforming the time-series training data into the frequency domain data for each explanatory variable of the time-series training data;
comparing the frequency domain data that belong to different classes, respectively, for each explanatory variable of the time-series training data, the frequency domain data corresponding to the time-series training data; and
calculating the time width based on a difference between the frequency domain data for each explanatory variable of the time-series training data, and determining the time width based on the calculated time width of each explanatory variable.

7. The information processing apparatus according to claim 6, wherein the instructions comprise:
performing machine learning by a predetermined learned model by use of the time-series training data set by the determined time width;
based on a result of the machine learning, for each explanatory variable of the time-series training data, calculating an importance degree of the explanatory variable; and further
determining the time width based on the importance degree of each explanatory variable and the time width calculated for each explanatory variable.

8. The information processing apparatus according to claim 7, wherein the instructions comprise:
calculating the importance degree of the explanatory variable based on a ratio at which the explanatory variable contributes to output in the learned model; and
determining the time width based on the time width of the explanatory variable whose importance degree of the explanatory variable is determined to be a high value according to a preset standard.

9. A non-transitory computer-readable storage medium having a computer program stored thereon, the computer program comprising instructions for causing an information processing apparatus to execute processing of:
transforming time-series training data into frequency domain data;
comparing the frequency domain data that belong to different classes, respectively, the frequency domain data corresponding to the time-series training data; and
determining a time width of the time-series training data based on a comparison result of the frequency domain data, the time width being set at a time of performing machine learning of the time-series training data.

10. An information processing method comprising:
transforming time-series training data into frequency domain data;
comparing the frequency domain data that belong to different classes, respectively, the frequency domain data corresponding to the time-time series training data; and
determining a time width of the time-series training data based on a comparison result of the frequency domain data, the time width being set at a time of performing machine learning of the time-series training data.

11. The information processing method according to claim 10, wherein:
at a time of comparing the frequency domain data, a frequency difference between the frequency domain data at frequency peak locations is calculated; and
the time width is determined based on the frequency difference between the frequency domain data at the frequency peak locations.

12. The information processing method according to claim 1 wherein the time width is determined so that the time width is larger as a value of the frequency difference is smaller.

13. The information processing method according to claim 11, wherein the time width is determined based on the frequency difference between the frequency domain data at locations where frequency peaks of the frequency domain data are determined to be high according to a preset standard.

14. The information processing method according to claim 10, wherein the time width is determined based on a minimum value of frequencies at frequency peak locations of the frequency domain data.

15. The information method according to claim 10, wherein:
the time-series training data is transformed into the frequency domain data for each explanatory variable of the time-series training data;
the frequency domain data that belong to different classes, respectively, are compared for each explanatory variable of the data; time-series training data, the frequency domain data corresponding to the time-series training data; and
the time width is calculated based on a difference between the frequency domain data for each explanatory variable of the time-series training data, and the time width is determined based on the calculated time width of each explanatory variable.

16. The information processing method according to claim 15, comprising:
after determining the time width, performing machine learning by a predetermined learned model by use of the time-series training data set by the determined time width;
based on a result of the machine learning, for each explanatory variable of the time-series training data, calculating an importance degree of the explanatory variable; and further
determining the time width based on the importance degree of each explanatory variable and the calculated time width of each explanatory variable.

17. The information processing method according to claim 16, comprising:
calculating the importance degree of the explanatory variable based on a ratio at which the explanatory variable contributes to output in the learned model; and
determining the time width based on the time width of the explanatory variable whose importance degree of the explanatory variable is determined to be a high value according to a preset standard.
